(19) United States
(12) Patent Application Publication
(10) Pub. No.: US 2020/0174435 A1
(43) Pub. Date: Jun. 4, 2020

(54) Energy Information System, and Method and Device for Processing Energy Information

(71) Applicants: GREE ELECTRIC APPLIANCES (WUHAN) CO., LTD, Wuhan, Hubei (CN); GREE ELECTRIC APPLIANCES, INC. OF ZHUHAI, Zhuhai City, Guangdong (CN)

(72) Inventors: Xiao LUO, Zhuhai, Guangdong (CN); Zhigang ZHAO, Zhuhai, Guangdong (CN); Shizhuo SHAO, Zhuhai, Guangdong (CN); Guocong SHE, Zhuhai, Guangdong (CN); Lingjun WANG, Zhuhai, Guangdong (CN)

(21) Appl. No.: 16/613,377

(22) PCT Filed: Feb. 28, 2018
(86) PCT No.: PCT/CN18/77479

§ 371 Date: Nov. 13, 2019

(30) Foreign Application Priority Data
May 19, 2017 (CN) 201710357855.3

(51) Int. Cl. G05B 19/042; H04L 12/66; H04L 12/46

(52) U.S. Cl. CPC G05B 19/042; G05B 2219/2639; H04L 12/4633; H04L 12/66

(57) ABSTRACT

Disclosed are an energy information system, and a method and a device for processing energy information. The method comprises: collecting, by means of at least one information gateway, energy information of at least one energy apparatus, wherein the at least one information gateway is connected to the corresponding energy apparatus; acquiring, by means of a central processing unit, the collected energy information, and transmitting the energy information to a server; and performing, by means of the server, analysis on the energy information to obtain an analysis result, wherein the analysis result is used to control the at least one energy apparatus. The present invention solves a technical problem of low energy utilization efficiency resulting from lack of a turnkey solution for an energy Internet.

### CROSS-REFERENCE TO RELATED APPLICATIONS

This application is a US 371 Application from PCT/CN2018/077479 filed Feb. 28, 2018, which claims priority to Chinese Application No. CN 201710357855.3, titled “ENERGY INFORMATION SYSTEM, AND METHOD AND DEVICE FOR PROCESSING ENERGY INFORMATION,” filed May 19, 2017, the contents of which are herein incorporated by reference in their entirety.

### TECHNICAL FIELD

The present disclosure relates to the field of energy information, more specifically, to an energy information system, and a method and a device for processing energy information.

### BACKGROUND

Energy Internet is one of the hot topics nowadays, especially in the past two years, the country has issued relevant policies to promote the development of this emerging industry, which should not only reduce the consumption of traditional energy, but also actively explore the use of new energy, and make all-round sustainable and efficient use.

With the development trend of energy Internet, many enterprises are also stepping up the transformation, but more from a single field, such as photovoltaic module power generation, charging pile, energy metering, energy management, etc., lack of a turnkey solution for the energy Internet.

In view of the above problem, no effective solution has been provided.

### SUMMARY

The embodiment of the present invention provides an energy information system, and a method and a device for processing energy information, to solve a technical problem of low energy utilization efficiency due to lack of a turnkey solution for the energy internet.

According to one aspect of the embodiment of the present invention, an energy information system is provided, which includes: at least one energy device, at least one information gateway connected to the at least one energy device and configured to collect energy information of the at least one energy device, a central processing unit connected to the at least one information gateway and configured to transmit the energy information collected by the at least one information gateway to a server, and the server connected to the central processing unit and configured to analyze the energy information to obtain an analysis result and control the at least one energy device according to the analysis result.

Optionally, the at least one energy device includes a first device, a second device, a third device and a fourth device; the first device is configured to generate energy; the second device is configured to store energy; the third device is configured to supply energy; and the fourth device is configured to consume energy.

Optionally, the energy information includes first information and second information; the first information is configured to record energy data of the at least one energy device; and the second information is configured to record characteristic data of the at least one energy device.

Optionally, the first information and the second information are encapsulated according to a preset communication format.

Optionally, the system further includes an Human-Machine Interface (HMI) and a terminal application, the HMI and the terminal application are respectively connected to the central processing unit to monitor the energy information.

Optionally, the server displays the analysis result through a web.

Optionally, the system further includes: an operation platform connected to the server and configured to receive an operation instruction and perform an energy operation according to the operation instruction.

According to another aspect of the present disclosure, a method for processing energy information is provided, which includes: collecting, by means of at least one information gateway, energy information of at least one energy device, the at least one information gateway being connected to the at least one energy device; acquiring, by means of a central processing unit, the collected energy information, and transmitting the energy information to a server; and analyzing, by means of the server, the energy information to obtain an analysis result for controlling the at least one energy device.

Optionally, the energy information includes first information and second information; the first information is configured to record energy data of the at least one energy device; the second information is configured to record characteristic data of the at least one energy device; the acquiring, by means of the central processing unit, the collected energy information and transmitting the energy information to the server includes: acquiring, by means of the central processing unit, the first information and the second information; encapsulating, by means of the central processing unit, the first information and the second information according to a preset communication format; and transmitting the first information and the second information encapsulated according to the preset communication format to the server.

According to another aspect of the present disclosure, a device for processing energy information is provided, which includes: a collecting unit configured to collect energy information of at least one energy device through at least one information gateway, the at least one information gateway being connected to the at least one energy device, an acquiring unit configured to acquire, by means of a central processing unit, the collected energy information, and transmit the energy information to a server, an analyzing unit configured to analyze, by means of the server, the energy information to obtain an analysis result for controlling the at least one energy device.

According to another aspect of the present disclosure, an electronic device is provided, which includes: at least one processor and a memory in communication with the at least one processor, the memory stores an instruction executable by the at least one processor, and the instruction is executed by the at least one processor to enable the at least one processor to execute the method for processing energy information described above.

According to another aspect of the present disclosure, a storage medium is provided, which includes a program stored therein, a device provided with the storage medium is controlled to execute the method for processing energy information described above when running the program.

According to another aspect of the present disclosure, a processor is provided and configured to run a program, the method for processing energy information described above is executed when running the program.

In the embodiment of the invention, the system is provided and includes: at least one energy device, at least one information gateway connected to the at least one energy device and configured to collect energy information of the at least one energy device, a central processing unit connected to the at least one information gateway and configured to transmit the energy information collected by the at least one information gateway to a server, and the server connected to the central processing unit and configured to analyze the energy information to obtain an analysis result and control the at least one energy device according to the analysis result. Free access to and connectivity of the energy information are implemented through the system, and the objectives of energy monitoring, energy control and statistical analysis are achieved, so as to implement the technical effect of optimizing energy configuration, and further solve the technical problem of low energy utilization efficiency due to lack of a turnkey solution for the energy Internet.

### BRIEF DESCRIPTION OF THE DRAWINGS

The accompanying drawings described herein are provided for further understanding the present disclosure and constitute a part of the disclosure. The exemplary embodiments of the invention and the description thereof are provided for illustration of the disclosure, but not intended to limit the present disclosure. In the accompanying drawings:

FIG. 1 is a schematic diagram of an energy information system according to an embodiment of the present invention;

FIG. 2 is a flowchart of a method for processing energy information according to an embodiment of the present invention;

FIG. 3 is a schematic diagram of a device for processing energy information according to an embodiment of the present invention.

### DETAILED DESCRIPTION OF THE EMBODIMENTS

In order to enable those skilled in the art to better understand the solution of the present disclosure, the technical solutions of the embodiments of the present invention will be described clearly and in detail with reference to the accompanying drawings in the embodiments of the present disclosure. Apparently, the embodiments described below are several but not all embodiments of the present application. For those skilled in the art, all other embodiments obtained based on the embodiments of the present invention without creative work are within the scope of the present disclosure.

It should be noted that the terms “first”, “second” and the like in the description and claims and drawings of the present disclosure are used for distinguishing similar objects, but not intended to describe a specific order or sequence. It should be appreciated that such terms are interchangeable under appropriate circumstances, so that the embodiments of the present invention described herein can be implemented in an order other than the order shown in the drawings or described herein. In addition, the terms “including” and “having” and any variations thereof are intended to cover a non-exclusive inclusion. For example, a process, a method, a system, a product or a device including a series of steps or units, is not definitely limited to those expressly listed steps or units, but may include other steps or units which are not expressly listed or inherent to the process, the method, the product or the device.

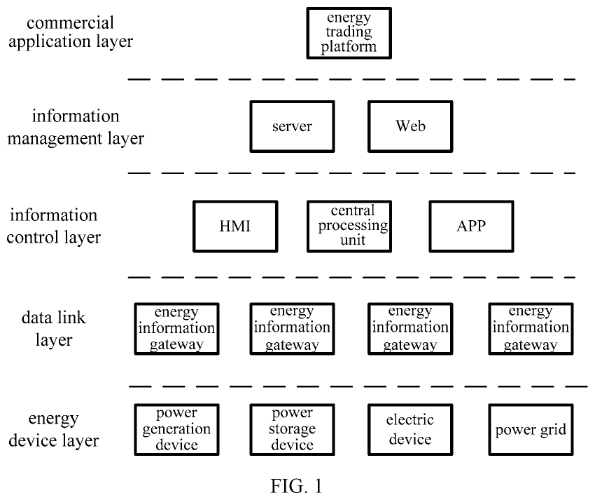

According to an embodiment of the present invention, an energy information system is provided. As shown in FIG. 1, the system includes:

at least one energy device;

at least one information gateway, connected to at least one energy device and configured to collect energy information of at least one energy device;

a central processing unit, connected to at least one information gateway and configured to transmit the energy information collected by the at least one information gateway to a server;

the server, connected to the central processing unit and configured to analyze the energy information to obtain an analysis result and control at least one energy device according to the analysis result.

In the embodiment of the present invention, free access to and connectivity of the energy information are implemented through the system, and the objectives of energy monitoring, energy control and statistical analysis are achieved, so as to implement the technical effect of optimizing energy configuration, and further solve the technical problem of low energy utilization efficiency due to lack of a turnkey solution for the energy Internet.

As shown in FIG. 1, in the energy information system provided by the embodiment of the present invention, at least one energy device can serve as an energy device layer of the system. The energy device can generate, store, consume and supply energy. Preferably, at least one energy device includes a first device, a second device, a third device and a fourth device. The first device is configured to generate energy; the second device is configured to store energy; the third device is configured to supply energy; and the fourth device is configured to consume energy. For example, the first device may be a power generation device configured to generate the electric energy; the second device may be a power storage device configured to store electric energy; the third device may be a power grid configured to distribute power and supply power; and the fourth device may be an electric device configured to consume electric energy.

At least one information gateway serves as a data link layer in the system, and is configured to collect the energy information of the above-mentioned energy device. For example, the information gateway (such as, the energy information gateway shown in FIG. 1) can collect energy data of the energy device, such as a voltage, a current, a power, an electric quantity and so on. Moreover, the information gateway may implement collection and compatibility of various energy information.

The central processing unit, as an information control layer in the system, is bridged with the data link layer, to acquire the energy information collected by the information gateway and transmit the energy information to the server. The information control layer may further include an Human-Machine Interface (HMI) and a terminal application (such as the APP in FIG. 1). The HMI and the terminal application are respectively connected to the central processing unit to monitor the energy information. The HMI may display the energy information through a human-machine interaction. For example, the HMI may be a touch screen, and the terminal application may be a software client which can be installed on a terminal device, such as a mobile phone APP and the like. The monitoring of the energy information can be implemented through the HMI and the terminal application.

Preferably, the energy information includes first information and second information. The first information is configured to record energy data of the at least one energy device; the second information is configured to record the characteristic data of at least one energy device. After acquiring the energy information, such as a voltage, a current, a power, an electric quantity collected by the information gateway and a mode, a temperature, a wind speed, a state of on-off of the electric device and so on, the central processing unit classifies the energy information. The energy information such as the voltage, the current, the power, the electric quantity are classified as the energy data, while the energy information such as the mode, the temperature, the wind speed, the state of on-off are classified as the characteristic data.

Preferably, the first information and the second information are encapsulated according to a preset communication format. Before transmitting the energy information to the server, the central processing unit encapsulates the first information and the second information in the energy information according to the preset communication format, and distinguishes them by means of a function code. The communication format is shown in table 1:

TABLE 1

| | | | | | |
|---|---|---|---|---|---|
| Function | Number of | Data 1 | Data 2 | . . . | Data n |
| Code | Data | | | | |

The energy data can be denoted by the function code 01, and the characteristic data can be denoted by the function code 02. Take the transmission of the energy data as an example, the transmitted data is shown in table 2:

TABLE 2

| Function | Number of | | | | |
|---|---|---|---|---|---|
| Code | Data | Voltage | Current | Power | Electric Quantity |
| 01 | 04 | 220 | 10 | 38 | 5 |

Field-level communication is implemented among the information control layer, the data link layer and the energy device layer, which supports multiple networks access and can employ direct-current carrier communication under the condition that the wiring is complex, to implement the data transmission through power lines, thereby avoiding complicated wiring and construction. The field-level communication can adopt a fieldbus host-less network to actively transmit the energy data collected by the data link layer to the data bus when the energy data collected by the data link layer changes, and then the associated devices may actively acquire the energy data from the data bus, thereby implementing point-to-point, real-time and effective data transmission. For example, when the energy data collected by the information gateway changes, the energy data is actively transmitted to the fieldbus data, the central module monitors the fieldbus data in real time and actively acquires the energy data and transmits the energy data to the server, so as to ensure that the communication updates in real time.

In the energy information system provided by the embodiment of the present invention, as an information management layer, the server is connected to an information control layer through the Internet, and the connection mode may be a wired connection or a wireless connection. Through analyzing the energy information, the information management layer implements centralized management and analysis of regional energies, energy overview, energy scheduling and intelligent control of energy devices. Optionally, the server can display the analysis result through a web (e.g., the web in FIG. 1).

Optionally, the system further includes an operation platform (e.g., an energy trading platform of a commercial application layer in FIG. 1), which is connected to the server and configured to receive an operation instruction and perform an energy operation according to the operation instruction. The operation platform can be used for energy trade. A user sends out an operation instruction through the operation platform to complete an energy trade, thereby implementing free trade of energy.

According to the embodiments of the present invention, a method for processing energy information is provided. It should be noted that the steps shown in the flowchart of the drawings can be performed in a computer system capable of executing a set of computer instructions. Furthermore, although a logical order is shown in the flowchart, in some situations, the steps shown or described in the flowchart can be performed in a different order than that shown in the flowchart.

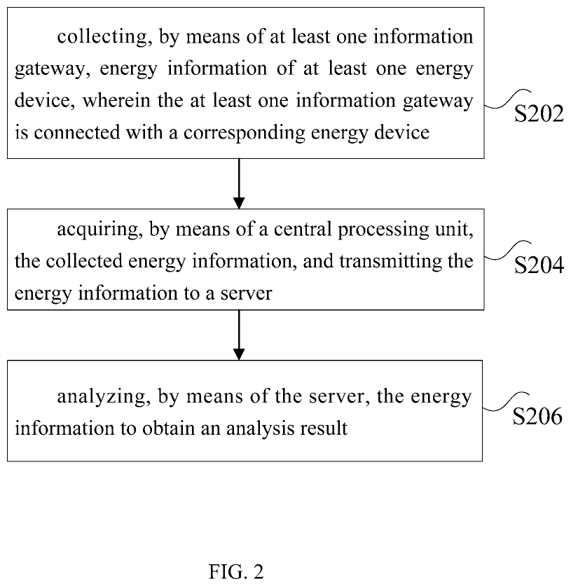

According to the embodiments of the present application, an embodiment of the method for processing energy information is provided. FIG. 2 is a flowchart of a method for processing energy information according to an embodiment of the present application. As shown in FIG. 2, the method includes the following steps.

Step S202: energy information of at least one energy device is collected by at least one information gateway, the at least one information gateway is connected to a corresponding energy device.

Step S204: the collected energy information is acquired by a central processing unit, and the energy information is transmitted to a server.

Step S206: the energy information is analyzed by the server to obtain an analysis result for controlling the at least one energy device.

In the embodiment of the present invention, the energy information of at least one energy device is collected by at least one information gateway, the at least one information gateway is connected to a corresponding energy device; the collected energy information is acquired by the central processing unit and sent to the server; the energy information is analyzed by the server, to obtain the analysis result for controlling the mode of the at least one energy device. Through free accesses to and connectivity of the energy information, the objectives of energy monitoring, energy control and statistical analysis are achieved, thereby implementing the technical effect of optimizing energy configuration, and further solving the technical problem of low energy utilization efficiency due to lack of a turnkey solution for the energy internet.

The at least one information gateway may be configured to collect the energy information of the energy device. For example, the information gateway can collect energy data of the energy device, such as a voltage, a current, a power, an electric quantity and so on. Moreover, the information gateway can implement the collection and compatibility of various energy information.

The central processing unit acquires the energy information collected by the information gateway and sends the energy information to the server. The information control layer may further include an HMI and a terminal application. The HMI and the terminal application are respectively connected to the central processing unit and configured to monitor the energy information. The HMI may display the energy information through a human-machine interaction. For example, the HMI may be a touch screen, and the terminal application may be a software client installed on a terminal device, such as a mobile phone APP and the like. The monitoring of the energy information can be implemented through the HMI and the terminal application.

Optionally, the energy information includes first information and second information. The first information is configured to record the energy data of the at least one energy device, and the second information is configured to record the characteristic data of the at least one energy device. The step of acquiring the collected energy information by the central processing unit and transmitting the energy information to the server includes: the first information and the second information are acquired by the central processing unit, the first information and the second information are encapsulated by the central processing unit according to a preset communication format; and the first information and the second information encapsulated according to the preset communication format are transmitted to the server.

After acquiring the energy information, such as a voltage, a current, a power, an electric quantity collected by the information gateway and a mode, a temperature, a wind speed, a state of on-off of the electric device and so on, the central processing unit classifies the energy information. The energy information like the voltage, the current, the power, the electric quantity are classified as energy data, and the energy information like the mode, the temperature, the wind speed, the state of on-off are classified as characteristic data. Before transmitting the energy information to the server, the central processing unit encapsulates the first information and the second information in the energy information according to the preset communication format, and distinguishes them by means of a function code. The communication format is shown in table 1:

TABLE 1

| | | | | | |
|---|---|---|---|---|---|
| Function | Number of | Data 1 | Data 2 | . . . | Data n |
| Code | Data | | | | |

The energy data can be denoted by the function code 01, and the characteristic data can be denoted by the function code 02. Take the transmission of the energy data as an example, the transmitted data is shown in table 2.

TABLE 2

| Function | Number of | | | | |
|---|---|---|---|---|---|
| Code | Data | Voltage | Current | Power | Electric Quantity |
| 01 | 04 | 220 | 10 | 38 | 5 |

The server is connected to an information management layer through the Internet, and the connection mode may be a wired connection or a wireless connection. Through analyzing the energy information, the information management layer implements centralized management and analysis of regional energies, energy overview, energy scheduling and intelligent control of energy devices.

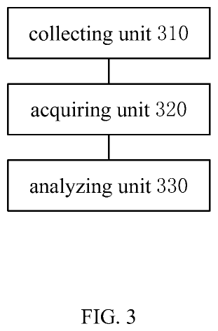

According to the embodiment of the present invention, an embodiment of a device for processing energy information is provided. FIG. 3 is a schematic diagram of a device for processing energy information according to an embodiment of the present invention, as shown in FIG. 3, the device includes:

an collecting unit 310, configured to collect energy information of at least one energy device through at least one information gateway, the at least one information gateway being connected to the at least one energy device;

an acquiring unit 320, configured to acquire, by a central processing unit, the collected energy information acquired, and transmit the energy information to a server;

an analyzing unit 330, configured to analyze, by means of the server, the energy information to obtain an analysis result for controlling at least one energy device.

The at least one information gateway is configured to collect the energy information of the energy device. For example, the information gateway may collect energy data of the energy device, such as a voltage, a current, a power, an electric quantity and so on. Moreover, the information gateway may implement the collection and compatibility of the energy information.

The central processing unit acquires the energy information collected by the information gateway and transmits the energy information to the server. The information control layer may further include an HMI and a terminal application. The HMI and the terminal application are respectively connected to the central processing unit and configured to monitor the energy information. The HMI may display the energy information through a human-machine interaction. For example, the HMI may be a touch screen, and the terminal application may be a software client which can be installed on a terminal device, such as a mobile phone APP and the like. The monitoring of the energy information can be implemented through the HMI and the terminal application.

The server is connected to an information management layer through the Internet, and the connection mode may be a wired connection or a wireless connection. Through analyzing the energy information, the information management layer implements centralized management and analysis of regional energies, energy overview, energy scheduling and intelligent control of energy devices.

According to the embodiment of the present application, also provided is an electronic device including: at least one processor, and a memory in communication with the at least one processor. The memory stores an instruction executable by the at least one processor, and the instruction is executed by the at least one processor, so as to enable the at least one processor to execute the method for processing energy information described above.

According to the embodiment of the present invention, also provided is a storage medium, which includes a program stored therein. When running the program, a device provided with the storage medium is controlled to execute the method for processing energy information described above.

According to the embodiment of the present invention, also provided is a processor for running a program, the method for processing energy information described above is executed when running the program.

The serial numbers of the embodiments of the present invention are only used for illustration, not indicating preference order among the embodiments.

In the above embodiments of the invention, the description of each embodiment has its own emphasis. For the parts not specified in one embodiment, please refer to the relevant description of other embodiments.

In several embodiments of this present invention, it should be understood that the disclosed technical content may be implemented in other ways. The device embodiments described above are merely schematic, such as the division of units, which can be a division of logical functions, and there may be another way of division when actually implementing, for example, multiple units or components can be combined or integrated into another system, or some features can be ignored or not performed. On the other hand, the coupling or direct coupling or communication connection between each other shown or discussed may be an indirect coupling or communication connection through some interfaces, units or modules, which may be electrical or other form.

The units described as separate components may or may not be physically separate, and the components displayed as units may or may not be physical units, that is, may be located in one place, or may be distributed to multiple units. Some or all of the units may be selected according to actual requirements to implement the objective of the solution of the embodiment.

In addition, each functional unit in each embodiment of the present invention can be integrated into a processing unit, or each unit may physically exist separately, or two or more than two units are integrated into one unit. The above integrated unit may be implemented in a form of hardware, or in a form of a software functional unit.

When the integrated unit is implemented in the form of a software functional unit and is sold or used as an independent product, the integrated unit may be stored in a computer readable storage medium. Based on this understanding, The technical solution of the present disclosure in essence or the part contributing to the prior art, or all or part of the technical solution can be embodied in the form of a software product. The computer software product can be stored in a storage medium, and includes a number of instructions that enable a computer device (may be a personal computer, a server, or a network device) to execute all or part of steps of the method described in various embodiments of the present invention. The above-mentioned storage medium includes various media capable of storing program codes, such as a U disk, a Read-Only Memory (ROM), a Random Access Memory (RAM), a removable hard disk, a magnetic disk, an optical disk, or the like.

The above is only a preferred embodiment of the present application, and it should be noted that those skilled in the art can also make several improvements and modifications without departing from the principles of the present disclosure, which should be regarded as scope of protection of the disclosure.

1. An energy information system, comprising:
at least one energy device,
at least one information gateway, connected to the at least one energy device and configured to collect energy information of the at least one energy device,
a central processing unit, connected to the at least one information gateway and configured to transmit the energy information collected by the at least one information gateway to a server, and
the server, connected to the central processing unit and configured to analyze the energy information to obtain an analysis result and control the at least one energy device according to the analysis result.

2. The energy information system according to claim 1, wherein the at least one energy device comprises a first device, a second device, a third device and a fourth device; wherein,
the first device is configured to generate energy;
the second device is configured to store energy;
the third device is configured to supply energy; and
the fourth device is configured to consume energy.

3. The energy information system according to claim 1, wherein the energy information comprises first information and second information; wherein,
the first information is configured to record energy data of the at least one energy device; and
the second information is configured to record characteristic data of the at least one energy device.

4. The energy information system according to claim 3, wherein the first information and the second information are encapsulated according to a preset communication format.

5. The energy information system according to claim 1, wherein the system further comprises an Human-Machine Interface (HMI) and a terminal application, and the HMI and the terminal application are respectively connected to the central processing unit and configured to monitor the energy information.

6. The energy information system according to claim 1, wherein the server displays the analysis result through a web.

7. The energy information system according to claim 1, wherein the system further comprises:
an operation platform, connected to the server and configured to receive an operation instruction and perform an energy operation according to the operation instruction.

8. A method for processing energy information, comprising:
collecting, by means of at least one information gateway, energy information of at least one energy device, wherein the at least one information gateway is connected to a corresponding energy device;
acquiring, by means of a central processing unit, the collected energy information, and transmitting the energy information to a server; and
analyzing, by means of the server, the energy information to obtain an analysis result, wherein the analysis result is configured to control the at least one energy device.

9. The method according to claim 8, wherein the energy information comprises first information and second information; the first information is configured to record energy data of the at least one energy device; the second information is configured to record characteristic data of the at least one energy device; the acquiring, by means of the central processing unit, the collected energy information and transmitting the energy information to the server comprise:
obtaining, by means of the central processing unit, the first information and the second information;
encapsulating, by means of the central processing unit, the first information and the second information according to a preset communication format; and
transmitting the first information and the second information encapsulated according to the preset communication format to the server.

10. A device for processing energy information, comprising:
an collecting unit, configured to collect energy information of at least one energy device through at least one information gateway, wherein the at least one information gateway is connected to the at least one energy device;
an acquiring unit, configured to acquire, by means of a central processing unit, the collected energy information, and transmit the energy information to a server;
an analyzing unit, configured to analyze, by means of the server, the energy information to obtain an analysis result, wherein the analysis result is configured to control the at least one energy device.

11.-13. (canceled)
